(19) United States
(12) Patent Application Publication
(10) Pub. No.: US 2014/0137904 A1
(43) Pub. Date: May 22, 2014

(54) MODULAR RECYCLER AND HEAVY DUTY PARTS WASHER APPARATUS

(71) Applicant: SystemOne Technologies, Miami, FL (US)

(72) Inventors: Carlos R. Suarez, Miami, FL (US); Christopher Hiatt, Smyrna, GA (US)

(73) Assignee: SystemOne Technologies, Miami, FL (US)

(21) Appl. No.: 14/075,651

(22) Filed: Nov. 8, 2013

Related U.S. Application Data
(63) Continuation-in-part of application No. 13/178,716, filed on Jul. 8, 2011.
(60) Provisional application No. 61/399,248, filed on Jul. 8, 2010.

(51) Int. Cl. B08B 3/14; B08B 3/00

(52) U.S. Cl. CPC B08B 3/14; B08B 3/006
USPC 134/109

(57) ABSTRACT

A modular recycler and heavy duty parts washer apparatus for use with a reservoir containing a cleaning solution includes a recycler unit for recycling the cleaning solution that is contained in the reservoir, a wash basin and cabinet surrounding an internal cavity and including an inner facing surface and a track on the inner facing surface sized and configured to support a platform, and the platform being structured to move inwards and outwards from the internal cavity along the tracks of the cabinet, and the platform having a top side that is adapted for removable mounting of the reservoir and recycler unit thereon, wherein the combined assembly of the platform, reservoir and recycler unit can moved inwards and outwards of the internal cavity along the tracks of the cabinet. Each of the recycler unit, cabinet, wash basin and reservoir are individually replaceable.

This application is a Continuation-In-Part (CIP) patent application of co-pending patent application serial number No. 13/178,716 filed on Jul. 8, 2011, which is based on provisional patent application Ser. No. 61/399,248, filed on Jul. 8, 2010.

### BACKGROUND OF THE INVENTION

1. Field of the Invention

The present invention relates to a modular apparatus for recycling cleaning solvents used to wash parts with modular add-on components to provide for a fully integrated recycler/parts washer.

2. Discussion of the Related Art

During maintenance, repair and rebuilding operations in virtually all industrial and commercial environments, it is necessary to wash a wide variety of parts and articles in order to remove grease, oil, dirt and other contaminants. Typically, volatile solvents are used in almost all small parts cleaning operating as they have been found to be most effective in removing grease and other accumulated residue from metal parts and other articles. A well known and widely used means for washing automotive, aviation, marine, industrial and general parts, components and tools during service, maintenance, repair, rebuilding operations, etc., involves using a sink-on-a-drum apparatus in which a sink basin is placed on top of and installed to a drum containing a cleaning solvent (e.g. a 16 or 30 gallon drum). A pump is provided which pumps the solvent from the drum to a spigot in the sink basin, where the solvent is used to rinse and clean parts. The solvent then leaves the sink basin and returns to the drum (along with any contaminants removed from the parts). The contaminated solvent is continuously used (and therefore becomes more and more contaminated) during cleaning operations until it is eventually replaced with a clean drum of solvent (e.g. on a monthly basis). The method for replacing the drum involves manually lifting the sink basin off of the drum, replacing the drum with a new drum, and then reinstalling the sink basin on the new drum. The contaminated drum of solvent must then be taken away and disposed of in a manner complying with EPA contaminant disposal guidelines.

The conventional sink-on-a-drum apparatus has two major drawbacks. First, the volatile solvent in the drum becomes progressively contaminated as it is used more and more, and by the time the drum is replaced, the solvent has become so contaminated that it is less effective as a cleaning agent and inefficient to use by mechanics and other workers. Second, the method of replacing the drum can be unsafe and hazardous because service personnel who replace drums can injure themselves (e.g., back injury) while lifting the heavy sink basins off of and onto the drums. This results in the filing of worker's compensation claims that can be very costly to solvent service providers.

To overcome the problems associated with standard sink-on-a-drum parts washers, various solvent recycling machines have been developed that allow for either small batch recycling of contaminated cleaning solvent or integrated recycling of an entire storage reservoir (e.g., tank) of cleaning solvent that has become contaminated after parts cleaning operations. These currently existing solvent recycling machines have an arrangement of integrated components that are not easily separated for repair or replacement. Accordingly, when one component breaks or malfunctions, the entire machine is out of commission until it can be repaired.

In light of the shortcomings associated with the prior art, there remains a need for a completely modular parts washer and recycling apparatus that allows for easier access to components, including a recycler unit and solvent containing drum, as well as easy and efficient separation, removal and replacement of components.

### Objects and Advantages of the Invention

Considering the foregoing, it is a primary object of the present invention to provide a modular, compact apparatus for integrating with a solvent-containing drum and which continuously recycles the solvent in the drum.

It is a further object of the present invention to provide a modular, compact apparatus which can be utilized independently as a stand-alone recycler unit.

It is a further object of the present invention to provide a modular recycler unit that can also be utilized as a fully integrated recycler/parts washer with the simple attachment and ease of replacement of add on components, including a wash basin and cabinet, a rolling platform in the cabinet for supporting solvent drums of various sizes, and a modular recycler supported on the rolling platform.

It is a further object of the present invention to provide a modular recycler/parts washer apparatus, as described above, which allows for easy, quick, and safe replacement of a solvent-containing drum.

It is a further object of the present invention to provide a modular recycler/parts washer apparatus, as described above, which allows for automatic priming on first use and which further provides the first gallon of distillate within two hours of commencing the recycle operation.

It is still a further object of the present invention to provide a modular recycler/parts washer apparatus, as described above, which provides a continuous flow of clean distillate throughout the recycle process utilizing latent heat in the distillation tank of the recycler unit to eliminate heating cycle times on sequential batches, reduce energy requirements and increase operating efficiency.

It is still a further object of the present invention to provide a modular recycler/parts washer apparatus, as described above, which has an integrated switched output that can be used to control the wash pump and/or light fixture of a traditional sink-on-a-drum parts washer or immersion style solvent washer and/or provide for an automatic off timer to reduce evaporative waste and energy usage.

It is still a further object of the present invention to provide a modular recycler/parts washer apparatus, as described above, which reduces the occurrence of injuries among workmen and thereby reduces the amount of workman's compensation claims for back injuries caused by removing and reinstalling heavy sink basins.

It is still a further object of the present invention to provide a modular recycler/parts washer apparatus, as described above, which recycles a batch of approximately 1 to 2 gallons of contaminated solvent per hour.

It is still a further object of the present invention to provide a modular recycler/parts washer apparatus, as described above, which extends the useful service life of the cleaning solvent thereby reducing the frequency of services required for the removal and replacement of contaminated cleaning solvent (e.g., from about once per month to about once per 2 to 3 months or longer).

It is still a further object of the present invention to provide a modular recycler/parts washer apparatus, as described above, which allows service providers to replace fewer drum or other solvent reservoirs, increases worker productivity and allots more time for other functions such as sales and customer service.

These and other objects and advantages of the present invention are more readily apparent with reference to the detailed description and accompanying drawings.

### SUMMARY OF THE INVENTION

The present invention is directed to a compact, modular and fully integrateable recycler/parts washer apparatus allowing for the safe and efficient integration of various separate modular components for washing automotive, aviation, marine, industrial and general parts, components and tools during service, maintenance, repair and rebuilding operations. The apparatus comprises a modular recycler component, a modular wash basin and cabinet component, a modular rolling platform component and a modular interconnect component. The apparatus is designed specifically for integration with universal cleaning solvent reservoirs (e.g. solvent-containing drums).

The core apparatus is a modular recycler unit for recycling volatile cleaning solvents which can be utilized independently as a stand-alone recycler unit in conjunction with any typically used parts washer apparatus including sink-on-a-drum or immersion type units in common use. The core modular recycler unit can also be utilized as a fully integrated recycler/parts washer with the simple attachment of add on components designed to complement the core recycler apparatus including a wash basin and cabinet in various dimensions and a rolling platform within the cabinet for supporting standard drums of various size that are used as the solvent reservoir as well as the recycler. The recycler parts washer apparatus is designed to allow for ease of integration of individual components, and replacement of individual components, including the wash basin and cabinet, the modular recycling unit and the solvent containing drum. The design of the recycler/parts washer apparatus serves to eliminate the commonly used practice of lifting off of heavy sink basins while providing the additional advantages of an integrated recycler/parts washer with a significantly reduced footprint as compared to commonly used parts washers in conjunction with separate recycler apparatuses. The core modular recycler unit serves to continually recycle the cleaning solvent by heating the solvent to produce vapors; the vapors pass through a condenser where it is cooled to a liquid state yielding clean solvent and then directed back into the drum for re-use. Contaminants are removed through a discharge port.

The wash basin and cabinet component, with the rolling platform for supporting the modular recycler component and the solvent reservoir, has a wide, rectangular-shaped sink-like area. A pump is connected to a conduit leading to the solvent reservoir (i.e., drum) and brings cleaning solvent up to a spigot and/or a nozzle and brush in the basin. Cleaning solvent leaves the basin through a drain which is connected to a conduit that leads back to the solvent reservoir (e.g., solvent-containing drum).

The recycler unit comprises a distillation chamber with heaters, a condenser with a fan, a distillate reservoir, a vacuum/fluid pump and a residue discharge port. During operation, individual batches of contaminated solvent are pumped from the solvent reservoir directly to the distillation chamber where the contaminated solvent is heated. The heating process serves to separate the contaminants from the clean solvent. Clean solvent becomes a vapor that is directed to the condenser where the vapor is cooled and transformed back into a liquid state. The liquid solvent is then pumped back into the solvent reservoir for continued use. The contaminants remain in a solid/liquid form and may be later removed through the residue discharge port.

A rolling platform allows for compact fitting and integration of the recycler/parts washer apparatus with the solvent reservoir to thereby reduce the overall footprint of the integrated apparatus and reservoir.

### BRIEF DESCRIPTION OF THE DRAWINGS

For a fuller understanding of the nature of the present invention, reference should be made to the following detailed description taken in conjunction with the accompanying drawings in which:

FIG. 1 is an exploded perspective view of the principal components of the modular recycler and heavy duty parts washer apparatus of the present invention;

FIG. 2 is a perspective view of the assembled apparatus of the present invention;

FIG. 3 is a perspective view of the assembled apparatus revealing the principal components of the modular recycler and heavy duty parts washer apparatus of the present invention;

FIG. 4 is a front elevational view of the assembled apparatus of the present invention;

FIG. 5 is a perspective view revealing the internal components of the core recycler component of the present invention; and

FIG. 6 is a schematic diagram illustrating the sequence of operations of the present invention according to the preferred embodiment.

Like reference numerals refer to like parts throughout the several views of the drawings.

### DETAILED DESCRIPTION OF THE PREFERRED EMBODIMENTS

Throughout the several views of the drawings, the modular recycler and heavy duty parts washer apparatus of present invention is shown and is generally indicated as 10.

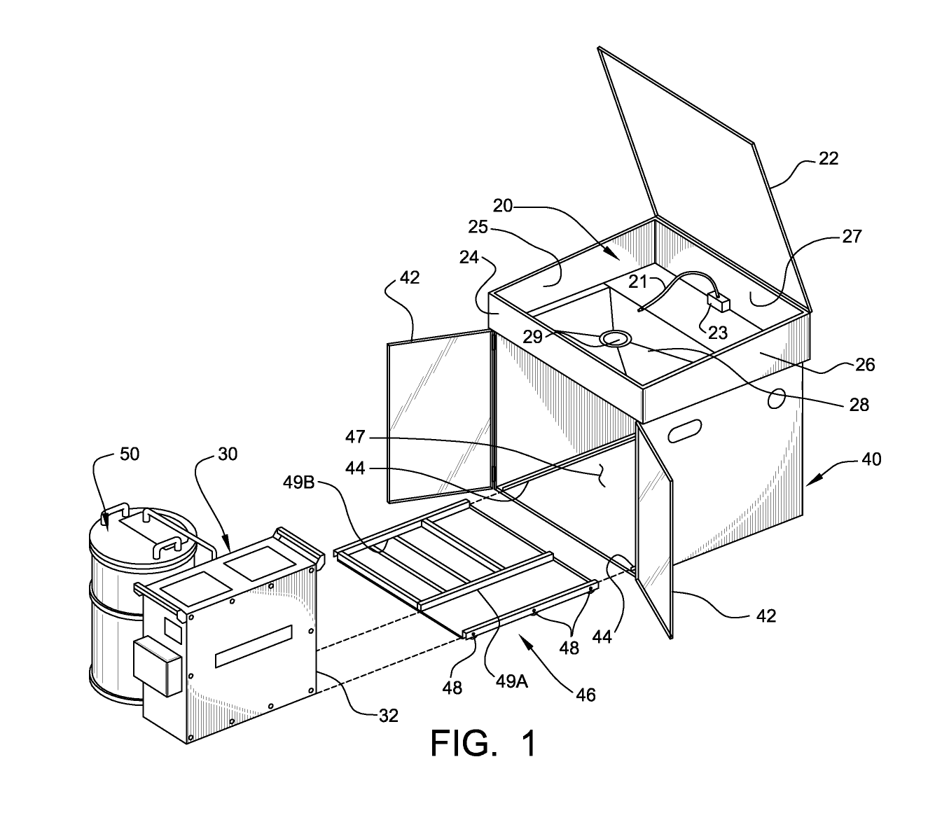

Referring to FIG. 1, the principal modular recycler and heavy duty parts washer apparatus 10 includes a wash basin 20, a core recycler component 30, and a cabinet 40. These principal components integrate with a solvent reservoir 50 (e.g. a solvent-containing drum). Each of the principle components (20, 30 and 40), along with solvent reservoir 50, are designed to allow for ease of integration of individual components, and replacement of individual components, including the wash basin 20 and cabinet 40, the core recycler component 30 and the solvent reservoir 50. The wash basin 20 is attachable to the top surface of the cabinet 40 and includes a top cover 22 for covering the wash basin 20. A hose 21 extends from a manifold valve 23 in the wash basin 20 for emitting the cleaning solvent for washing and scrubbing parts. The manifold valve 23 may be in connection with other cleaning instruments instead of, or in addition to, a hose 21, including a spigot and/or a nozzle and brush. The wash basin 20 includes a front wall 24, two sidewalls 25 and 26, and a rear wall 27 surrounding a sloped bottom surface 28 for directing used cleaning solvent into drain 29, which is in connection with the solvent reservoir 50.

The cabinet 40 includes doors 42 and tracks 44 for securing a platform 46 in the interior cavity 47 of the cabinet 40. A plurality of wheels 48 fitted to the underside of platform 46 are sized for receipt in tracks 44 to allow for guided inward and outward movement of the platform 46. The platform 46 includes compartments 49A and 49B for holding the core recycler component 30 and solvent reservoir 50, respectively.

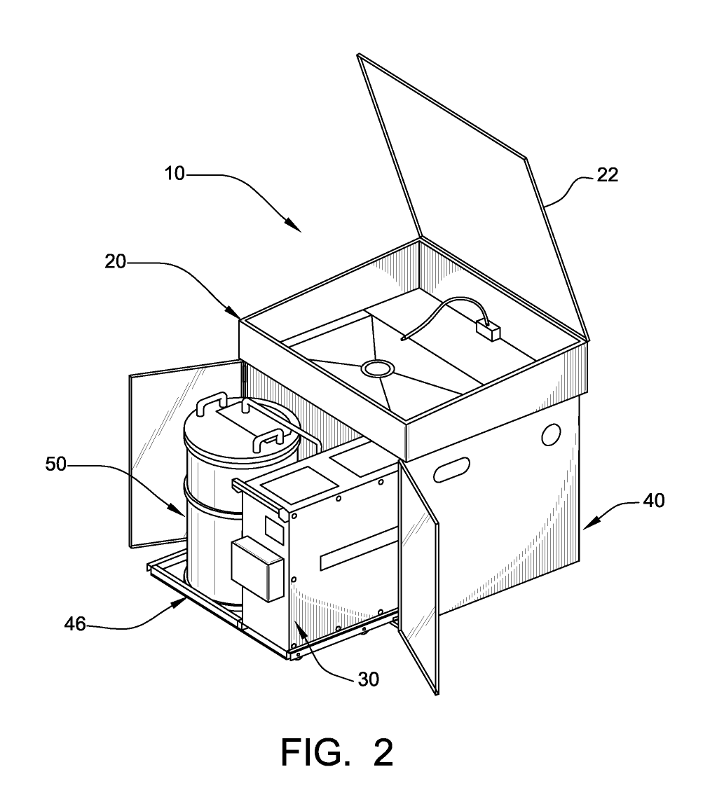

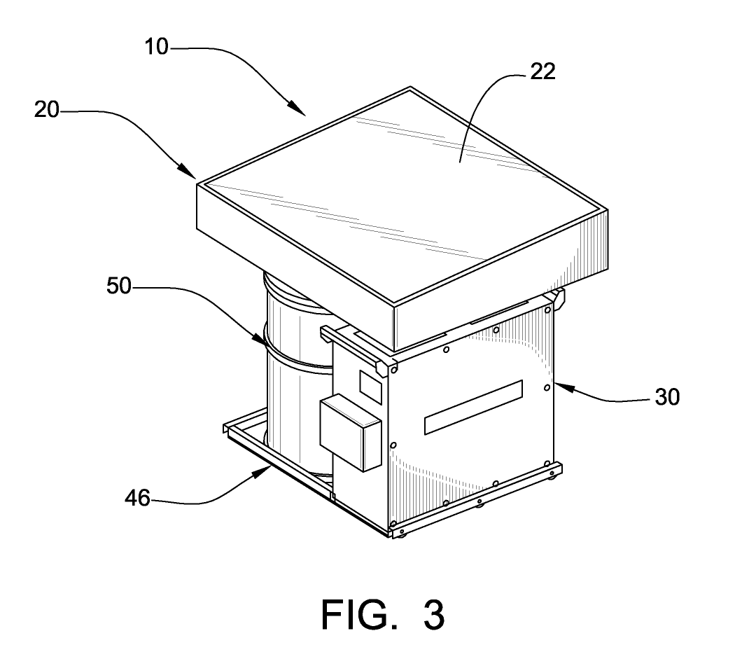

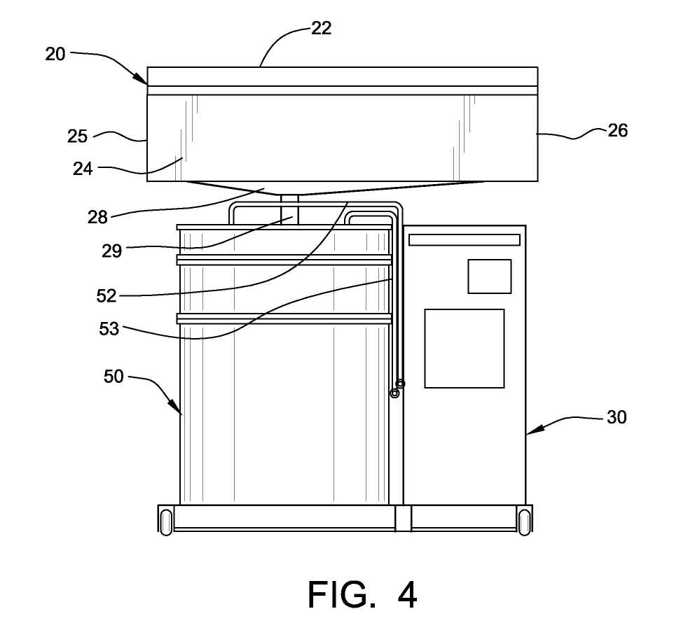

Referring to FIGS. 2-4, the principal components of the apparatus 10 are shown assembled together as a combined unit and integrated with the solvent reservoir 50. The core recycler component 30 can be removably mounted onto the top of the platform 46 in compartment 49A. Likewise, the solvent reservoir 50 can be removably mounted onto the top of the platform 46 in compartment 49B. The platform 46 is structured to move outwards from the interior cavity 47 of the cabinet 40 along tracks 44 to allow for easy access and replacement of used solvent reservoirs 50. The roll-out platform 46 also allows for easy access to the core recycler component 30 and, if necessary, removal and replacement of the recycler component 30. Referring specifically to FIG. 4, the solvent reservoir 50 includes a supply line 52 and return line 53 in connection with the recycler component 30 for cycling the cleaning solvent.

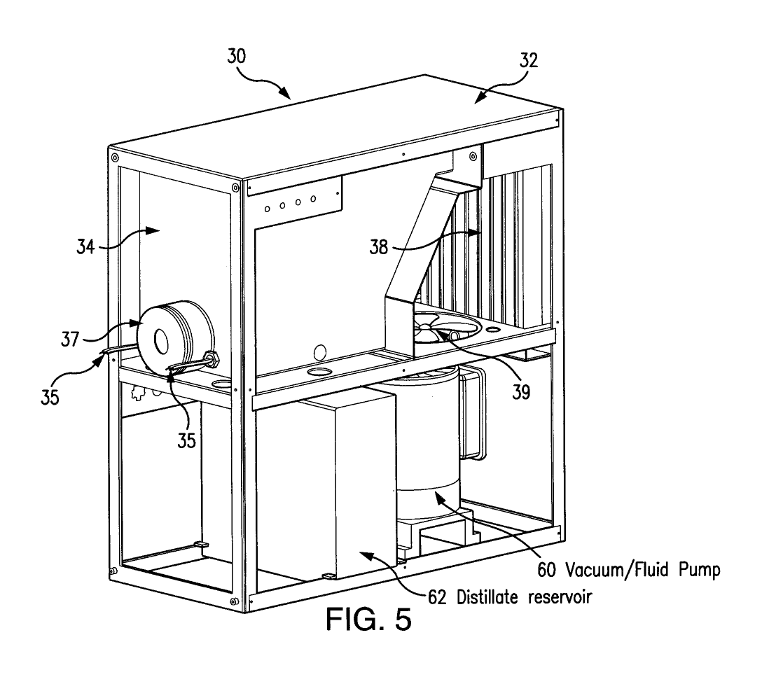

FIG. 5 is a more detailed perspective view of the core recycler component 30 which reveals the inner components. The outer housing 32 surrounds the inner components, including the distillation chamber 34. Contaminated solvent that is delivered to the core recycler component 30 from the reservoir 50 first enters into the distillation chamber 34. During the distillation cycle, the contaminated solvent is heated by heater 35 to cause separation of clean solvent from the contaminants. This is achieved by producing vapors, wherein the clean solvent separates from the contaminants in the form of vapors which are then delivered to the condenser 38. The contaminants remain in the distillation chamber 34 in liquid and/or solid form and are eventually removed through the residue discharge port 37. In the condenser, where the vapors are cooled by the fan 39 to produce a liquid distillate yielding pure (i.e., non-contaminated) cleaning solvent. The clean solvent is then directed to the clean distillate reservoir 62. Vacuum/fluid pump 60 is used to transfer the clean solvent from the distillate reservoir 62 back to the reservoir 50.

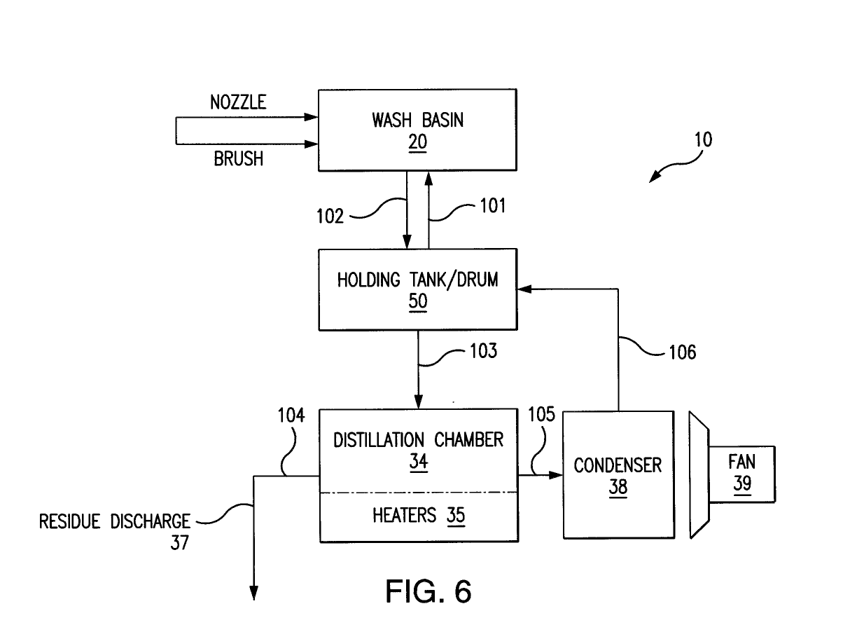

FIG. 6 is a schematic diagram illustrating the preferred operations of the modular recycler and heavy duty parts washer apparatus 10 of the present invention. In step 101, cleaning solvent is pumped from the reservoir 50 to the wash basin 20 where it is used to clean parts, components and tools. The solvent is then delivered back to the solvent reservoir 50 in step 102. Periodically, during continuous recycling operations, a batch (e.g., 1 to 2 gallons) of the partially contaminated cleaning solvent in the reservoir 50 (e.g., drum) is pumped from the reservoir to the distillation chamber 34 of the core recycler component 30, as indicated by step 103. Within the distillation chamber 34, the contaminated or partially contaminated cleaning solvent is heated by heaters 35 to cause the solvent to vaporize, as described above. The contaminants are removed from the apparatus through the residue discharge port 37 in step 104. The solvent vapor is transferred to the condenser in step 105 where the vapor is cooled and converted back into a liquid form with the use of cooling fan 39. In step 106, the clean liquid solvent, contained in the clean distillate reservoir, is pumped back to the solvent reservoir 50 where it may be again used to clean parts, components and tools. During continuous operations, partially contaminated batches of solvent are removed from the solvent reservoir 50 for recycling, and recycled cleaned batches of solvent are replaced back into the solvent reservoir 50, thereby prolonging the useful service life of the solvent and reducing the frequency of solvent reservoir (e.g., drum) removal and replacement.

While the present invention has been shown in accordance with several preferred and practical embodiments, it is recognized that departures from the instant disclosure are fully contemplated within the spirit and scope of the present invention which are not to be limited except as defined in the following claims as interpreted under the Doctrine of Equivalents.

What is claimed is:

1. A modular recycler and heavy duty parts washer apparatus for use with a reservoir containing a cleaning solution, said apparatus comprising:
a recycler unit for recycling the cleaning solution that is contained in the reservoir, and the recycler unit including an outer housing having a top and a bottom, and said housing surrounding an arrangement of internal recycler components including a distillation chamber, at least one solvent heater, a condenser, a cooling fan, and a pump, and the distillation chamber being adapted to receive contaminated cleaning solution from the reservoir, and the at least one solvent heater being structured and disposed for heating the contaminated cleaning solution in the distillation chamber for producing vapors which separate from contaminants in the contaminated cleaning solution, and the recycler unit being further structured to direct the vapors to the condenser wherein the cooling fan cools the vapors to produce non-contaminated, recycled cleaning solution, and the pump being structured and disposed for transferring the non-contaminated, recycled cleaning solution to the reservoir;
a cabinet surrounding an internal cavity and including an inner facing surface and a track on the inner facing surface sized and configured to support a platform, and said platform being structured to move inwards and outwards from the internal cavity along the tracks of said cabinet;
said platform having a top side that is adapted for removable mounting of the reservoir and recycler unit thereon, wherein the combined assembly of the platform, reservoir and recycler unit can moved inwards and outwards of the internal cavity along the tracks of said cabinet; and
wherein each of said recycler unit, cabinet and reservoir are individually replaceable.

2. The modular recycler and heavy duty parts washer apparatus as recited in claim 1 further comprising:
a residue discharge port on the recycler unit and communicating with the interior of the distillation chamber, and the residue discharge port being structured and disposed for allowing removal of contaminants from the interior of the distillation chamber.

3. The modular recycler and heavy duty parts washer apparatus as recited in claim 1 further comprising:
a wash basin for receiving the cleaning solution from the reservoir in order to wash parts, components, tools and other articles therein for removing contaminants, and said wash basin being mounted on a top surface of the cabinet and further defining the compact, integrated apparatus.

4. The modular recycler and heavy duty parts washer apparatus as recited in claim 3, wherein said wash basin is individually replaceable.

5. The modular recycler and heavy duty parts washer apparatus as recited in claim 1 wherein the recycler unit further comprises:
a clean distillate reservoir for receiving the non-contaminated, recycled cleaning solution from the condenser.

6. A modular recycler and heavy duty parts washer apparatus for use with a reservoir containing a cleaning solution, said apparatus comprising:
a recycler unit for recycling the cleaning solution that is contained in the reservoir, and the recycler unit including an outer housing having a top and a bottom, and said housing surrounding an arrangement of internal recycler components including a distillation chamber, at least one solvent heater, a condenser, a cooling fan, and a pump, and the distillation chamber being adapted to receive contaminated cleaning solution from the reservoir, and the at least one solvent heater being structured and disposed for heating the contaminated cleaning solution in the distillation chamber for producing vapors which separate from contaminants in the contaminated cleaning solution, and the recycler unit being further structured to direct the vapors to the condenser wherein the cooling fan cools the vapors to produce non-contaminated, recycled cleaning solution, and the pump being structured and disposed for transferring the non-contaminated, recycled cleaning solution to the reservoir;
a cabinet surrounding an internal cavity and including an inner facing surface and a track on the inner facing surface sized and configured to support a platform, and said platform being structured to move inwards and outwards from the internal cavity along the tracks of said cabinet;
said platform having a top side that is adapted for removable mounting of the reservoir and recycler unit thereon, wherein the combined assembly of the platform, reservoir and recycler unit can moved inwards and outwards of the internal cavity along the tracks of said cabinet;
a wash basin for receiving the cleaning solution from the reservoir in order to wash parts, components, tools and other articles therein for removing contaminants, and said wash basin being mounted on a top surface of the cabinet and further defining the compact, integrated apparatus; and
wherein each of said recycler unit, cabinet, wash basin and reservoir are individually replaceable.

7. The modular recycler and heavy duty parts washer apparatus as recited in claim 6 further comprising:
a residue discharge port on the recycler unit and communicating with the interior of the distillation chamber, and the residue discharge port being structured and disposed for allowing removal of contaminants from the interior of the distillation chamber.

8. The modular recycler and heavy duty parts washer apparatus as recited in claim 6 wherein the recycler unit further comprises:
a clean distillate reservoir for receiving the condensed non-contaminated, recycled cleaning solution from the condenser.
